(19) United States
(12) Patent Application Publication
(10) Pub. No.: US 2023/0308351 A1
(43) Pub. Date: Sep. 28, 2023

(54) SELF INSTANTIATING ALPHA NETWORK

(71) Applicant: RED HAT, INC., Raleigh, NC (US)

(72) Inventors: Luca Molteni, Cernusco Sul Naviglio (IT); Matteo Mortari, Binasco (IT)

(21) Appl. No.: 17/704,866

(22) Filed: Mar. 25, 2022

(51) Int. Cl. H04L 41/0823; H04L 41/0813; H04L 41/08

(52) U.S. Cl. CPC H04L 41/0823; H04L 41/0813; H04L 41/0883; H04L 41/12

(57) ABSTRACT

A method includes receiving a set of rules by a processing device executing a rule engine, generating a plurality of nodes of a Rete network based on the set of rules, and generating a network class based on the plurality of nodes. Each rule includes a predicate associated with a constraint of the rule. Each node includes an identification of a corresponding predicate and a meta-program associated with the corresponding predicate. The meta-program is used to generate a source code associated with a respective node based on the corresponding predicate.

### TECHNICAL FIELD

The present disclosure is generally related to rule engines, and more particularly, to a rules engine generating a self-instantiating alpha node of a RETE network.

### BACKGROUND

The development and application of rule engines is one branch of Artificial Intelligence (AI). Broadly speaking, a rules engine processes information by applying rules to data objects (also known as facts). A rule is a logical construct for describing the operations, definitions, conditions, and/or constraints that apply to some predetermined data to achieve a goal. Various types of rule engines have been developed to evaluate and process rules. Conventionally, a rules engine implements a network to process rules and data objects, such as a Rete Network. A network may include many different types of nodes, including, for example, object-type nodes, alpha nodes, left-input-adapter nodes, eval nodes, join nodes, terminal nodes, etc.

### BRIEF DESCRIPTION OF THE DRAWINGS

The present disclosure is illustrated by way of example, and not by way of limitation, and can be more fully understood with reference to the following detailed description when considered in connection with the figures in which:

FIG. 1 depicts a high-level component diagram of an example of a computer system architecture with a rule engine, in accordance with one or more aspects of the present disclosure.

FIG. 2A depicts a flow diagram of generating a self-instantiating alpha network, in accordance with one or more aspects of the present disclosure;

FIG. 2B depicts a flow diagram of instantiating and evaluating a fact using the self-instantiating alpha network alpha network having an in-lineable alpha node, in accordance with one or more aspects of the present disclosure;

FIG. 3 depicts a flow diagram of generating a self-instantiating alpha network, in accordance with one or more aspects of the present disclosure.

FIG. 4 depicts a flow diagram of a method for generating a self-instantiating alpha network, in accordance with one or more aspects of the present disclosure.

FIG. 5 depicts a flow diagram of a method for generating a self-instantiating alpha network, in accordance with one or more aspects of the present disclosure.

FIGS. 6A and 6B depicts exemplary embodiments implementing the rules engine of FIG. 1 in accordance with one or more aspects of the present disclosure.

FIG. 7 depicts a block diagram of an exemplary computer system operating in accordance with one or more aspects of the present disclosure.

### DETAILED DESCRIPTION

Described herein are methods and systems for generating a self-instantiating RETE network, in particular the alpha network of the RETE network. RETE network is a computational model for implementing rule-based systems, which is represented by a network of nodes, where each node (except the root) corresponds to a pattern occurring in the left-hand-side (the condition part) of a rule. The path from the root node to a leaf node defines a complete rule left-hand-side. RETE network consist of two parts an alpha network and a beta network. Alpha network consists of nodes known as alpha nodes. Each alpha node has one input that defines intra-elements. Beta network consists of beta nodes where each node takes two inputs to define inter-element conditions. In some instances, the alpha network may be optimized using hashing, alpha node sharing, indexing etc.

Alpha networks is a variation of a RETE network in which left-hand-side of the rules forms a discrimination network responsible for selecting facts (e.g., working memory elements) from working memory of a rules engine based on conditional tests which compares the facts attributes to a constant value. When facts are “asserted” to a working memory of the rules engine, the rules engine creates working memory elements (WMEs) for each fact. Nodes of the alpha network (e.g., alpha nodes) may also perform tests that compare two or more attributes of the same working memory elements. Each working memory element is passed along to the next alpha node, upon successful matching of the working memory elements to conditions represented by an alpha node, until the working memory element has traversed the alpha network.

Typically, in some rules engine, the immediate child nodes (e.g., the object type node) of a root node of the alpha network are used to test the entity identifier or fact type of each working memory element. The object type node may be implemented by a Java “instanceof” operation to test whether the working memory element (e.g., the asserted fact) is an instance of the specified type. Thus, all working memory elements which represent the same entity type typically traverse a given branch of alpha nodes in the discrimination network (e.g., alpha network). Each branch of alpha nodes terminates at a memory (e.g., an alpha memory), which stores collections of working memory elements that match each condition in each alpha node in a given alpha node branch. Working memory elements that fail to match at least one condition in a branch are not materialized within the corresponding alpha memory. The collections of working memory elements that match each condition in each alpha node in a given alpha node branch stored in the alpha memory is propagated to the rule terminal node which communicates with an agenda of the rules engine to contain the list of all rules that should be executed, along with the collection of working memory elements responsible for the conditions to be true.

Depending on the embodiment, to propagate a working memory element, the working memory element evaluated by the object type node and passed to an appropriate alpha node. The rules engine can implement a brute force approach evaluating each alpha node of the alpha network in sequence to identify the correct alpha node to evaluate against the working memory element. This brute force approach to identify the correct alpha node to evaluate against the working memory element, would, however, be computationally inefficient.

In some implementations, a network compiler (e.g., alpha network compiler) receives the alpha network to create a Java code representation (e.g., Java class) of the alpha network (e.g., a compiled alpha network). The compiled alpha network facilitates faster evaluation of constraints in comparison to the brute-forced method. The compiled alpha network contains references to each predicate (e.g., constraint) as a property of a Java class. During the evaluation, to instantiate the compiled alpha network, the rules engine receives the alpha network to identify the constraints in each alpha node of the received alpha network to set as a field in the Java class. While the compiled alpha network provides a faster evaluation of constraints, the rules engine must create and optimize the alpha network each time the rules engine wishes to create the compiled alpha network and/or instantiate the compiled alpha network. Accordingly, constant creation and optimization of the alpha network upon creation and/or instantiation of the compiled alpha network is computationally expensive and, in some instances, unnecessary. In particular, optimization techniques such as alpha node sharing and indexing are typically encoded into the compiled alpha network.

Alternatively, the series of rules associated with the custom business logic may be defined using an executable model. The executable modeling refers to a process model that is executable and can be directly used for automating the business logic. In other words, the executable model generates Java source code representation of the series of rules associated with the custom business logic providing faster startup time and better memory allocation. The executable model is compiled using a Java compiler (e.g., Javac) to generate a compiled bytecode class. The compiled bytecode class is instantiated to generate an instance of the alpha network associated with the series of rules. The instance of the alpha network is received by the network compiler (e.g., alpha network compiler) to create a Java source code representation (e.g., Java class) of the instantiated to generate an instance of the alpha network. Since the Java source code representation of the instantiated instance of the alpha network is not compatible with the executable model, the Java source code representation of the instance of the alpha network is compiled again using Java compiler (e.g., Javac) to generate a compiled bytecode class. This, however, results in multiple the Java compilations to create/instantiate the RETE network for submission into a network compiler and generate a compiled bytecode class based on the Java class generated by the network compiler.

Aspects of the present disclosure address the above and other deficiencies by generating a self-instantiating alpha network. In particular, the rules engine generates a robust alpha node (e.g., in-lineable alpha node) for each predicate (e.g., constraints) containing a method to generate Java source code to instantiate the alpha node based on the alpha node's identity. In an illustrative example, each alpha node comprises a string form of the constraint associated with the alpha node and a method for generating Java source code to be in-lined within the Java Class of the compiled alpha network. Each alpha node is linked together to create an alpha network. The alpha network is compiled into a compiled alpha network and transformed into a Java class representation of the compiled alpha network. Accordingly, to instantiate the Java Class of the compiled alpha network, the rules engine receives an object (e.g., a working memory element) to evaluate against the Java Class of the compiled alpha network, which includes the constraints, thereby removing the dependency of the alpha network to receive an alpha network to identify contraints associated with each alpha node as a means to instantiate the compiled alpha network.

Advantages of the present disclosure include, but are not limited to, improving efficiency and speed of evaluating alpha nodes of an alpha network and reducing the usage of computationally resources.

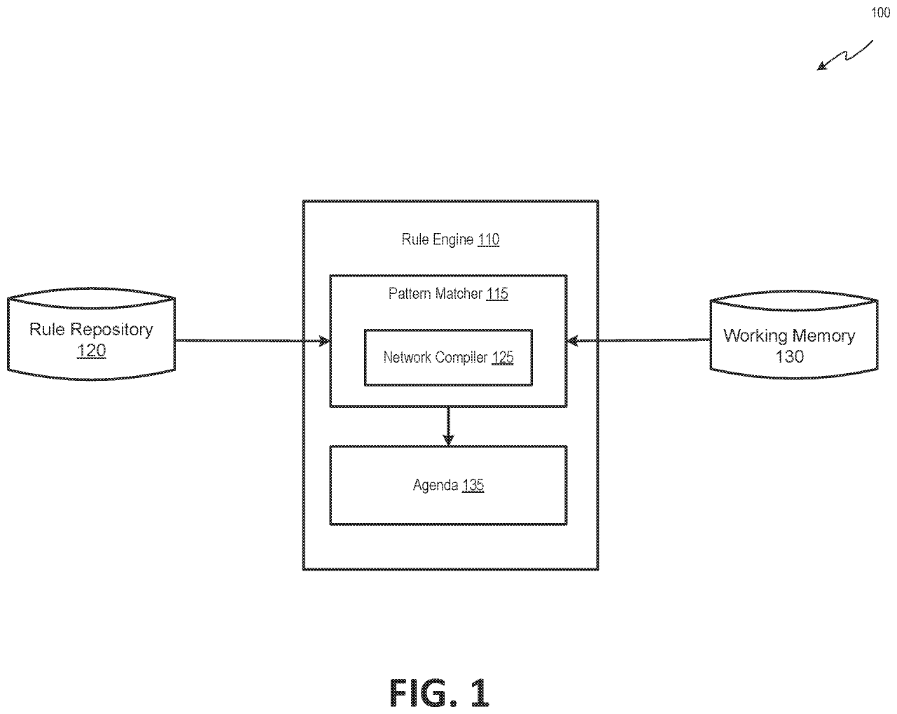

FIG. 1 illustrates an example system 100 that implements a rules engine 110. The system 100 includes a rule repository 120 and a working memory 130 in communication with the rules engine 110. The rule repository 120 (also referred to as a production memory) may include an area of memory and/or secondary storage that includes rules that will be used to evaluate expressions of objects (e.g., facts). The rule repository 120 may include one or more file systems, may be a rule database, may be a table of rules, or may be some other data structure for storing a rule set (also referred to as a rule base). Each rule in the rule set has a left hand side that corresponds to the constraints of the rule and a right hand side that corresponds to one or more actions to perform if the constraints of the rule are satisfied. The working memory 130 stores data objects (also referred to as objects) that have been asserted (e.g., objects that are to be matched against the rule set). Data objects that are received by the rules engine 110 may be added to the working memory 130. Data objects may also be removed from the working memory 130.

The rules engine 110, in particular, the pattern matcher 115 of the rules engine 110, creates a network (such as a Rete network) based on the rule set in the rule repository 120. The network is created by linking together nodes in which a majority of the nodes correspond to conditions associated with at least one rule from the rule set. Where multiple rules have the same condition, a single node may be shared by the multiple rules. The network is created to evaluate the rules from the rule repository 120 against the data objects (e.g., facts) from the working memory 130. As objects propagate through the network, the pattern matcher 115 may evaluate the objects against the rules and/or constraints derived from the rules in the rule repository 120. Fully matched rules and/or constraints may result in activations, which are placed into the agenda 135. The agenda 135 provides a list of rules to be executed and objects on which to execute the rules. The rules engine 110 may iterate through the agenda 135 to execute or fire the activations sequentially. Alternatively, the rules engine 110 may execute or fire the activations in the agenda 135 randomly.

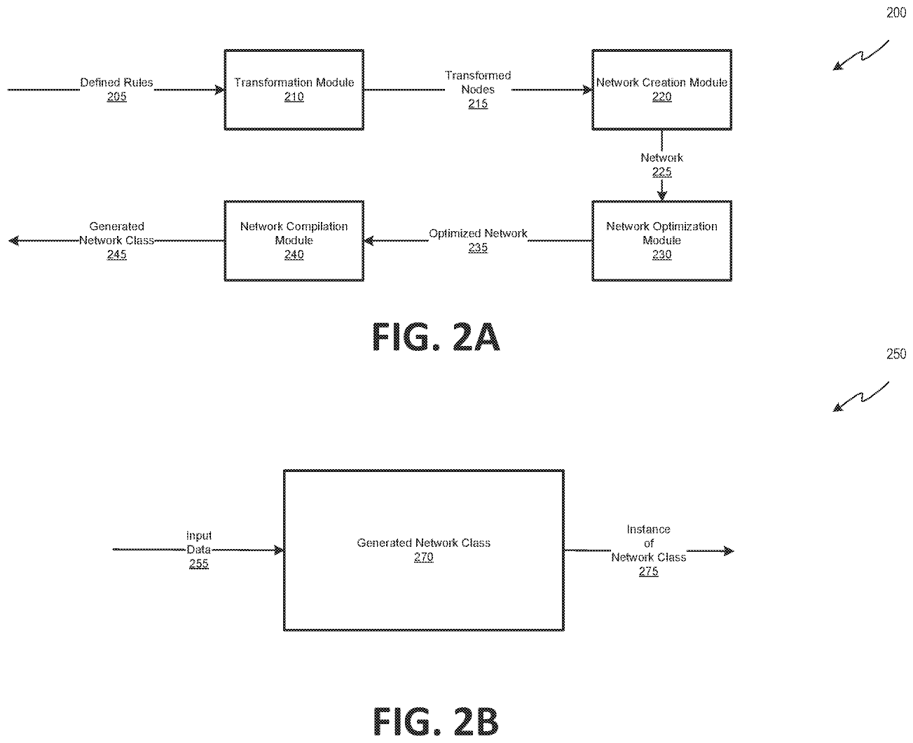

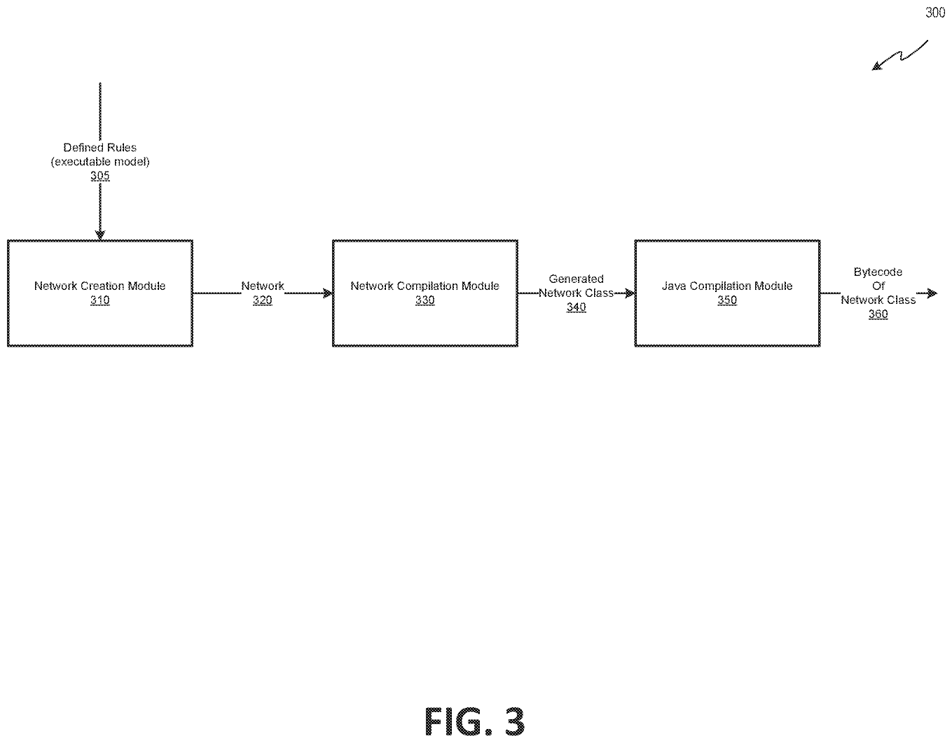

The rules engine 110 may further enable the generated self-instantiating alpha network and cause the self-instantiating alpha network to be instantiated. The rules engine may generate the self-instantiating alpha network by generating in-lineable alpha node for each rule comprising a constraint. The in-lineable alpha node refers to an alpha node comprising a string form of the constraint associated with the alpha node and a method for generating source code for the alpha node to be in-lined in a source code associated with the alpha network. The rules engine 110 may generate an alpha network based on the in-lineable alpha nodes. The rules engine 110 may compile the alpha network via an alpha network compiler to generate source code associated with the alpha network including in-lineable alpha nodes. To instantiate the generate source code associated with the alpha network, the rules engine 110 receives objects from the working memory 130 to evaluate the alpha network. The rules engine 110, based on the object, instantiates the alpha network using the source code associated with the alpha network. Accordingly, the alpha network may be instantiated without generating an alpha network to unwrap the constraints from the alpha nodes, as will be discussed in more detail in regards to FIG. 2A-B and FIG. 3.

FIG. 2A depicts an exemplary flow diagram of generating a self-instantiating alpha network in accordance with one or more aspects of the present disclosure. Rules engine 200 may be the same or similar to rules engine 110 of FIG. 1. In the example shown, rules engine 200 includes a transformation module 210, a network creation module 220, a network optimization module 230, a network compilation module 240, and a network class generation module 240.

Rule engine 200 receives from a rule repository (e.g., rule repository of FIG. 1) a plurality of rules 205 (e.g., at least one condition and/or constraint followed by at least one action). The rules 205 are received by a transformation module 210 to transform each predicate of the rules 205 into a transformed node 215 (e.g., an in-lineable alpha node). In particular, the transformation module 210 identifies from the rules 205 the constraint associated with the rules 205 and creates the transformed node 215 to receive an input to compare with the constraint. As described previously, each in-lineable alpha node contains a string form of a constraint associated with the alpha node and a method (e.g., meta-program) to generate Java source code to instantiate the alpha node based on the alpha node's identity. The transformed nodes 215 are received by the network creation module 220. The network creation module 220 creates a network 225 (e.g., an alpha network) based on the transformed nodes 215. As described previously, the network 225 is created by linking together the transformed nodes 215. The network 225 is received by a network optimization module 230 to optimize the network 225 via hashing, alpha node sharing, indexing etc. The network compilation module 240 receives the optimized network 235 to compile the optimized network 235 to generate a network class (e.g., alpha network java class). The network compilation module 240 generates a network class 245 by generating source code for the optimized network 235. The network compilation module 240 further generates, for each transformed node of the transformed nodes 215 associated with optimized network 235 (e.g., in-lineable alpha node), source code needed to instantiate each transformed node of the transformed nodes 215 by executing the method associated with each transformed node of the transformed nodes 215. The source code associated with the transformed nodes 215 are generated by executing the meta-program or the method associated with the transformed nodes 215. The meta-program or method associated with the transformed nodes 215 includes a set of instructions on how to generate Java source code to instantiate the alpha node based on the alpha node's identity. Once the source code needed to instantiate the transformed nodes 215 are generated, the source code associated with the transformed nodes 215 are in-lined into the source code of the optimized network 235 in their respective locations corresponding to the transformed node of the transformed nodes 215 in the source code. Accordingly, the network compilation module 240 outputs the generated network class 245.

FIG. 2B depicts an exemplary flow diagram of instantiating the self-instantiating alpha network in accordance with one or more aspects of the present disclosure. Rules engine 250 may be the same or similar to rules engine 110 of FIG. 1 or rules engine 200 of FIG. 2A. In the example shown, rules engine 250 includes a generated network 270 generated by the network compilation module 240 of FIG. 2A (e.g., the generated network class 245 of FIG. 2A).

Rules engine 250 receives at least one input data 255 from working memory (e.g., working memory 130 of FIG. 1). The at least one input data 255 from working memory may be a working memory element. As described previously, the working memory element may be a fact “asserted” to the working memory (e.g., working memory 130 of FIG. 1) of the rules engine 250. The rules engine 250 evaluates the input data 255 against the generated network class 270 and creates an instance of the network class 275 to be executed. In particular, the input data 255 is compared to generated network class 270 and based on the input data 255 matching the generated network class 270, the rules engine 250 creates the instance of the network class 275 to be executed in view of the input data 255.

FIG. 3 depicts another exemplary flow diagram of generating and instantiating a self-instantiating alpha network in accordance with one or more aspects of the present disclosure. A block diagram of a rules engine 300 operating in accordance with one or more aspects of the present disclosure. Rules engine 300 may be the same or similar to rules engine 110 of FIG. 1. In the example shown, rules engine 300 includes a network creation module 310, a network compilation module 330, and a java compilation module 350.

Rules engine 300 receives from a rule repository (e.g., rule repository of FIG. 1) a plurality of rules 305 defined using an executable model rules language. The rules 305 are translated via an executable model from the executable model rules language representation of the rules 305 to an alpha node including a method (e.g., meta-program) to generate Java source code to instantiate the alpha node based on the identity of the alpha node (e.g., similar to an in-lineable alpha node, as described previously). The network creation module 310 creates a network 320 (e.g., an alpha network) based on the rules 305. In particular, the network 320 is created by linking together the rules 305. The network compilation module 330 receives the network 320 to generate a network class 340 (e.g., alpha network java class). The network compilation module 330 generates a network class 340 by generating source code for the network 320 based on the rules 305. As described previously, the generated network class 340 is received by a java compilation module 350 to compile the generated network class 340 into compiled bytecode class 360 based on the generated network class 340.

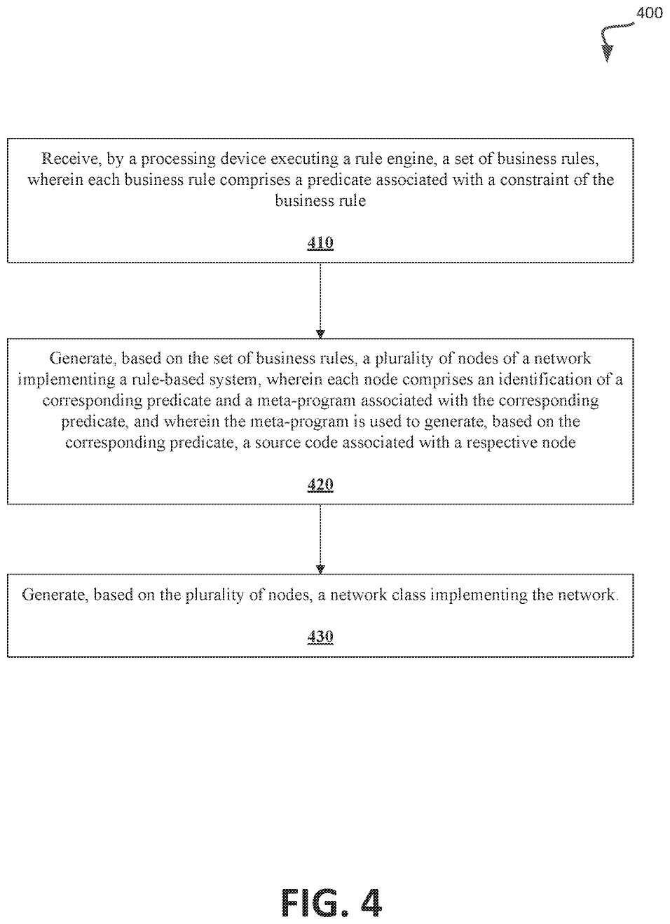

FIG. 4 depicts a flow diagram of an illustrative example of a method 400 for generating a self-instantiating alpha network, in accordance with one or more aspects of the present disclosure. Method 400 and each of its individual functions, routines, subroutines, or operations may be performed by one or more processors of the computer device executing the method. In certain implementations, method 400 may be performed by a single processing thread. Alternatively, method 400 may be performed by two or more processing threads, each thread executing one or more individual functions, routines, subroutines, or operations of the method. In an illustrative example, the processing threads implementing method 400 may be synchronized (e.g., using semaphores, critical sections, and/or other thread synchronization mechanisms). Alternatively, the processes implementing method 400 may be executed asynchronously with respect to each other.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

Method 400 may be performed by processing devices of a server device or a client device and may begin at block 410. At block 410, the processing device receives a set of business rules to be executed by a rule engine. As described previously, the rules engine is used to evaluate custom business logic. Each business rule include a predicate associated with a constraint of the business rule. As described previously, the set of business rules refers is part of a custom business logic derived from legal regulation, company policy, and/or other sources. The set of business rules may be defined based on an executable model language. As described previously, an executable model is used to generate Java source code representation of the set of business rules associated with the custom business logic providing faster startup time and better memory allocation.

At block 420, the processing logic generates, based on the set of business rules, a plurality of nodes of a Rete network. Each node include an identification of a corresponding predicate and a meta-program associated with the corresponding predicate. The meta-program or method is a series of instructions used to generate a source code associated with a respective node based on the corresponding predicate. As described previously, the rules engine generates a robust alpha node (e.g., in-lineable alpha node) for each predicate (e.g., constraints) containing a method to generate Java source code to instantiate the alpha node based on the alpha node's identity.

In some embodiments, the processing logic generates a network class based on the plurality of nodes. The network class may be a JAVA code representation of the plurality of nodes. To generate the network class, for each node of the plurality of nodes, the processing logic generates a respective source code based on a corresponding meta-program and inline the source code in the network class. To inline the source code in the network class, the processing logic replaces the node in the network class with the node source code.

In some embodiments, the processing logic receives a working memory element to be executed by the business rule engine. The working memory element may be an asserted fact referencing the constraint. The processing logic determines, based on the constraint referenced by the working memory element and the network class, a node of the plurality of nodes of the Rete network to evaluate. The processing logic further evaluates the node of the plurality of nodes of the Rete network based on the constraint referenced by the working memory element. Once the node is evaluated, the processing logic may traverse through the linked nodes.

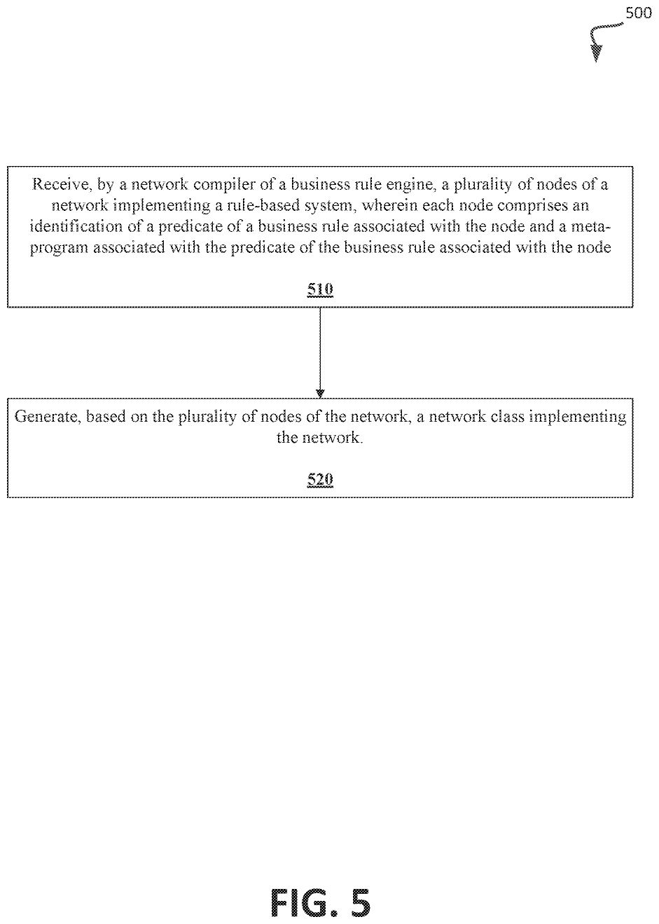

FIG. 5 depicts a flow diagram of an illustrative example of a method 500 for generating a self-instantiating alpha network, in accordance with one or more aspects of the present disclosure. Method 500 and each of its individual functions, routines, subroutines, or operations may be performed by one or more processors of the computer device executing the method. In certain implementations, method 500 may be performed by a single processing thread. Alternatively, method 500 may be performed by two or more processing threads, each thread executing one or more individual functions, routines, subroutines, or operations of the method. In an illustrative example, the processing threads implementing method 500 may be synchronized (e.g., using semaphores, critical sections, and/or other thread synchronization mechanisms). Alternatively, the processes implementing method 500 may be executed asynchronously with respect to each other.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

Method 500 may be performed by processing devices of a server device or a client device and may begin at block 510. At block 510, the processing logic receives, by a network compiler of a business rule engine, a plurality of nodes of a Rete network. As described previously, the network compiler receives the Rete network (e.g., alpha network) to create a Java source code representation (e.g., Java class or network class) of the Rete network (e.g., a compiled alpha network). Each node may include an identification of a predicate of a business rule associated with the node and a meta-program associated with the predicate of the business rule associated with the node. The meta-program may be used to generate a source code associated with a respective node based on the corresponding predicate. As described previously, the rules engine generates a robust alpha node (e.g., in-lineable alpha node) for each predicate (e.g., constraints) containing a method to generate Java source code to instantiate the alpha node based on the alpha node's identity.

At block 520, the processing logic generates a network class based on the plurality of nodes of the Rete network. To generate the network class, for each node of the plurality of nodes, the processing logic generates a node source code based on the meta-program and inline the source code in the network class.

In some embodiments, the processing logic receives a working memory element to be executed by the business rule engine. The working memory element may be an asserted fact referencing the constraint. The processing logic determines, based on the constraint referenced by the working memory element and the network class, a node of the plurality of nodes of the Rete network to evaluate. The processing logic further evaluates the node of the plurality of nodes of the Rete network based on the constraint referenced by the working memory element. Once the node is evaluated, the processing logic may traverse through the linked nodes.

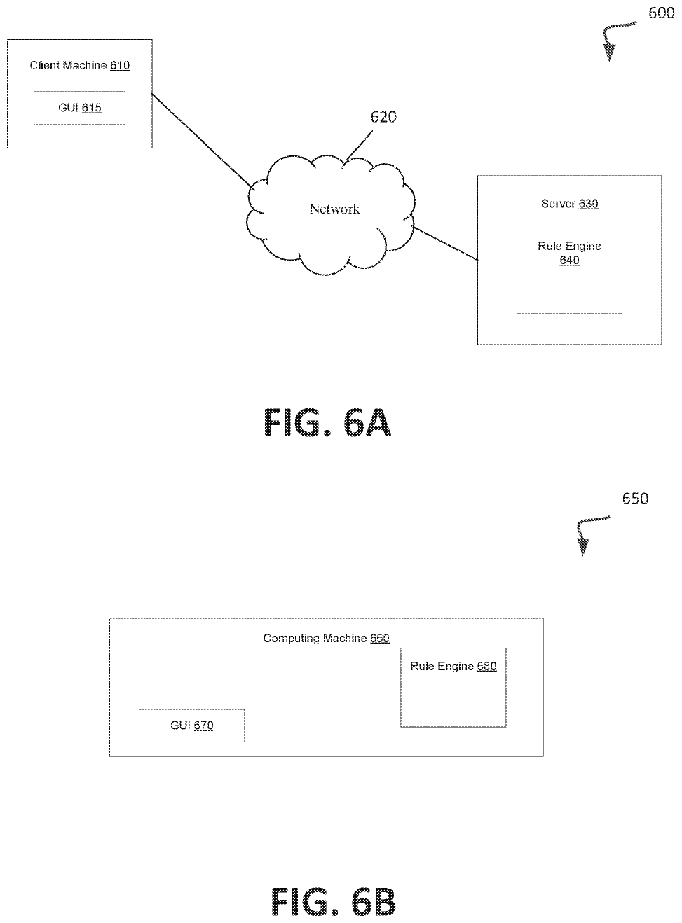

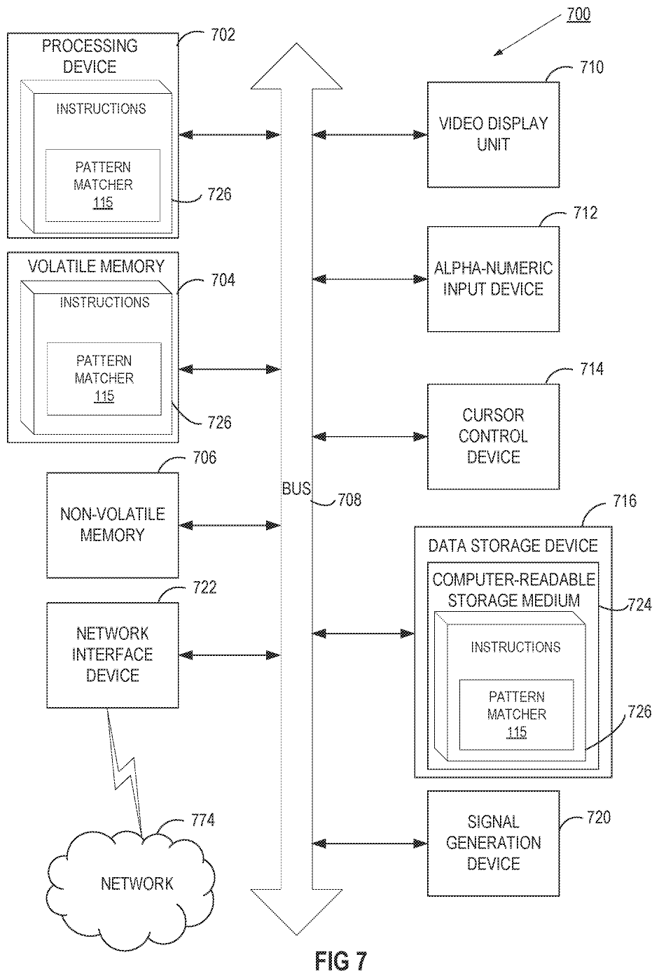

FIG. 6A depicts an exemplary embodiment implementing the rules engine of FIG. 1. The system 600 includes a client machine 610 and a server 630, which are coupled to each other via a network 620. The client machine 610 may include a computing machine, such as a desktop personal computer (PC), a laptop PC, a personal digital assistant (PDA), a mobile telephone, etc. The server 630 may be implemented using the computer system 700 as illustrated in FIG. 7. In some embodiments, the server 630 includes a rules engine 640 having an architecture as illustrated in FIG. 1. The client machine 610 may present a graphical user interface (GUI) 615 (e.g., a webpage rendered by a browser) to allow users to input rule sets and/or data objects, which may be sent to the server 630 to be processed using the rules engine 640 as discussed above. FIG. 6B depicts another exemplary embodiment implementing the rules engine of FIG. 1. The system 650 includes a computing machine 660, which may be implemented using the computer system 700 as illustrated in FIG. 7. The computing machine 660 includes a rules engine 680 and a GUI 670. In some embodiments, users may input files for rules using the GUI 670. Then the files may be processed by rules engine 680 as discussed above.

FIG. 7 depicts an example computer system 700, which can perform any one or more of the methods described herein. In one example, computer system 700 may correspond to computer system 100 of FIG. 1. The computer system may be connected (e.g., networked) to other computer systems in a LAN, an intranet, an extranet, or the Internet. The computer system may operate in the capacity of a server in a client-server network environment. The computer system may be a personal computer (PC), a set-top box (STB), a server, a network router, switch or bridge, or any device capable of executing a set of instructions (sequential or otherwise) that specify actions to be taken by that device. Further, while a single computer system is illustrated, the term “computer” shall also be taken to include any collection of computers that individually or jointly execute a set (or multiple sets) of instructions to perform any one or more of the methods discussed herein.

The exemplary computer system 700 includes a processing device 702, a main memory 704 (e.g., read-only memory (ROM), flash memory, dynamic random access memory (DRAM) such as synchronous DRAM (SDRAM)), a static memory 706 (e.g., flash memory, static random access memory (SRAM)), and a data storage device 716, which communicate with each other via a bus 708.

Processing device 702 represents one or more general-purpose processing devices such as a microprocessor, central processing unit, or the like. More particularly, the processing device 702 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 may also be one or more special-purpose processing devices such as an application-specific integrated circuit (ASIC), a field-programmable gate array (FPGA), a digital signal processor (DSP), network processor, or the like. The processing device 702 is configured to execute processing logic (e.g., instructions 726) that includes the pattern matcher 115 for performing the operations and steps discussed herein (e.g., corresponding to the method of FIGS. 2-5, etc.).

The computer system 700 may further include a network interface device 722. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 720 (e.g., a speaker). In one illustrative example, the video display unit 710, the alphanumeric input device 712, and the cursor control device 714 may be combined into a single component or device (e.g., an LCD touch screen).

The data storage device 716 may include a non-transitory computer-readable medium 724 on which may store instructions 726 that include pattern matcher 115 (e.g., corresponding to the methods of FIGS. 2-5, etc.) embodying any one or more of the methodologies or functions described herein. Pattern matcher 115 may also reside, completely or at least partially, within the main memory 704 and/or within the processing device 702 during execution thereof by the computer system 700, the main memory 704, and the processing device 702 also constituting computer-readable media. Pattern matcher 115 may further be transmitted or received via the network interface device 722.

While the computer-readable storage medium 724 is shown in the illustrative examples to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding, or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media. Other computer system designs and configurations may also be suitable to implement the systems and methods described herein.

Although the operations of the methods herein are shown and described in a particular order, the order of the operations of each method may be altered so that certain operations may be performed in an inverse order or so that certain operations may be performed, at least in part, concurrently with other operations. In certain implementations, instructions or sub-operations of distinct operations may be in an intermittent and/or alternating manner.

It is to be understood that the above description is intended to be illustrative and not restrictive. Many other implementations will be apparent to those of skill in the art upon reading and understanding the above description. Therefore, the scope of the disclosure should be determined with reference to the appended claims, along with the full scope of equivalents to which such claims are entitled.

In the above description, numerous details are set forth. However, it will be apparent to one skilled in the art that aspects of the present disclosure may be practiced without these specific details. In some instances, well-known structures and devices are shown in block diagram form rather than in detail in order to avoid obscuring the present disclosure.

Unless specifically stated otherwise, as apparent from the following discussion, it is appreciated that throughout the description, discussions utilizing terms such as “receiving,” “determining,” “providing,” “selecting,” “provisioning,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for specific purposes, or it may comprise a general-purpose computer selectively activated or reconfigured by a computer program stored in the computer. Such a computer program may be stored in a computer-readable storage medium, such as, but not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Aspects of the disclosure presented herein are not inherently related to any particular computer or other apparatus. Various general-purpose systems may be used with programs in accordance with the teachings herein, or it may prove convenient to construct a more specialized apparatus to perform the specified method steps. The structure for a variety of these systems will appear as set forth in the description below. In addition, aspects of the present disclosure are not described with reference to any particular programming language. It will be appreciated that a variety of programming languages may be used to implement the teachings of the disclosure as described herein.

Aspects of the present disclosure may be provided as a computer program product that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not to be construed as preferred or advantageous over other aspects or designs. Rather, the use of the words “example” or “exemplary” is intended to present concepts in a concrete fashion. As used in this application, the term “or” is intended to mean an inclusive “or” rather than an exclusive “or.” That is, unless specified otherwise or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, the use of the term “an embodiment” or “one embodiment” or “an implementation” or “one implementation” throughout is not intended to mean the same embodiment or implementation unless described as such. Furthermore, the terms “first,” “second,” “third,” “fourth,” etc., as used herein, are meant as labels to distinguish among different elements and may not have an ordinal meaning according to their numerical designation.

What is claimed is:

1. A method comprising:
receiving, by a processing device executing a rule engine, a set of rules, wherein each rule comprises a predicate associated with a constraint of the rule; and
generating, based on the set of rules, a plurality of nodes of a network implementing a rule-based system, wherein each node comprises an identification of a corresponding predicate and a meta-program associated with the corresponding predicate, and wherein the meta-program is used to generate, based on the corresponding predicate, a source code associated with a respective node; and
generating, based on the plurality of nodes, a network class implementing the network.

2. The method of claim 1, wherein the source code associated with the respective node is a source code used to instantiate the respective node.

3. The method of claim 1, wherein the network class is an executable code representation of the plurality of nodes.

4. The method of claim 1, wherein generating the network class further comprises:
for each node of the plurality of nodes, generating, based on a corresponding meta-program, a respective node source code; and
inlining the node source code in the network class.

5. The method of claim 4, wherein inlining the source code in the network class comprises:
replacing the node in the network class with the node source code.

6. The method of claim 1, further comprising:
receiving, by the processing device executing the rule engine, a working memory element;
determining, based on a constraint referenced by the working memory element and the network class, a node of the plurality of nodes of the network to evaluate; and
evaluating, based on the constraint referenced by the working memory element, the node of the plurality of nodes of the network.

7. The method of claim 6, wherein the working memory element is an asserted fact referencing the constraint of the node of the plurality of nodes.

8. The method of claim 1, wherein the set of rules are defined using an executable model language.

9. A system comprising:
one or more processing units to:
receive, by a processing device executing a rule engine, a set of rules, wherein each rule comprises a predicate associated with a constraint of the rule; and
generate, based on the set of rules, a plurality of nodes of a network implementing a rule-based system, wherein each node comprises an identification of a corresponding predicate and a meta-program associated with the corresponding predicate, and wherein the meta-program is used to generate, based on the corresponding predicate, a source code associated with a respective node; and
generate, based on the plurality of nodes, a network class implementing the network.

10. The system of claim 9, wherein the source code associated with the respective node is a source code used to instantiate the respective node.

11. The system of claim 9, wherein the network class is an executable code representation of the plurality of nodes.

12. The system of claim 9, wherein generating the network class further comprises:
for each node of the plurality of nodes, generating, based on a corresponding meta-program, a respective node source code; and
inlining the node source code in the network class.

13. The system of claim 12, wherein inlining the source code in the network class comprises:
replacing the node in the network class with the node source code.

14. The system of claim 11, wherein the processing device to further perform operations comprising:
receiving, by the processing device executing the rule engine, a working memory element;
determining, based on a constraint referenced by the working memory element and the network class, a node of the plurality of nodes of the network to evaluate; and
evaluating, based on the constraint referenced by the working memory element, the node of the plurality of nodes of the network.

15. The system of claim 14, wherein the working memory element is an asserted fact referencing the constraint of the node of the plurality of nodes.

16. The system of claim 9, wherein the set of rules are defined using an executable model language.

17. A non-transitory computer-readable storage medium comprising instructions that, when executed by a processing device, cause the processing device to perform operations comprising:
receiving, by a network compiler of a rule engine, a plurality of nodes of a network implementing a rule-based system, wherein each node comprises an identification of a predicate of a rule associated with the node and a meta-program associated with the predicate of the rule associated with the node; and
generating, based on the plurality of nodes of the network, a network class implementing the network.

18. The non-transitory computer-readable storage medium of claim 17, wherein the meta-program is used to generate, based on a corresponding predicate, a source code associated with a respective node.

19. The non-transitory computer-readable storage medium of claim 17, wherein generating the network class comprises:
for each node of the plurality of nodes, generating, based on the meta-program, a node source code; and
inlining the source code in the network class.

20. The non-transitory computer-readable storage medium of claim 17, wherein the processing device is further to:
receiving, by the rule engine, a working memory element, wherein the working memory element is an asserted fact referencing a constraint of the node of the plurality of nodes;
determining, based on the constraint of the working memory element and the network class, a node of the plurality of nodes of the network to evaluate; and
evaluating, based on the constraint of the working memory element, the node of the plurality of nodes of the network.
